(19) United States
(12) Patent Application Publication
(10) Pub. No.: US 2008/0236982 A1
(43) Pub. Date: Oct. 2, 2008

(54) ELECTROMAGNETIC CLUTCH

(76) Inventor: Shen Zhao, Tokyo (JP)

Correspondence Address: Brinks Hofer Gilson & Line, P.O. Box 10395, Chicago, IL, 60610, US

(21) Appl. No.: 12/055,877

(22) Filed: Mar. 26, 2008

(30) Foreign Application Priority Data
Mar. 30, 2007 (JP) 2007-093329

(51) Int. Cl. F16D 27/06; F16D 13/58

(52) U.S. Cl. 192/84.961; 192/70.14; 192/84.6

(57) ABSTRACT

The present invention provides an electromagnetic clutch that can restrict output torque to a predetermined range against the variation of the voltage of the power supply and the environmental temperature. The electromagnetic clutch comprises: an armature; a rotor that attracts the armature; a plurality of slits that are formed in the armature and the rotor around circumferential directions thereof; and a plurality of annular attraction surfaces that are formed on the armature and the rotor which face each other. At least one of the circumferential sections cut in the circumferential direction at the position in the armature and the rotor where respectively face an inner slit wall of the other party, and at least one of the attraction surfaces are substantially equal to each other in area.

This application claims priority under 35 U.S.C. §119 to Japanese Patent Application No. JP2007-093329 filed Mar. 30, 2007, the entire content of which is hereby incorporated by reference.

### BACKGROUND OF THE INVENTION

1. Field of the Invention

The present invention relates to an electromagnetic clutch that can restrict output torque to a predetermined range thereof by improving efficiency of magnetic flux in a magnetic circuit and uniformly saturating the magnetic circuit.

2. Description of Related Art

The action principle of an electromagnetic clutch will be simply explained hereinafter. For example, a torque generation source of an electromagnetic clutch is a motor. Torque generated by the motor is transmitted via a worm gear, the rotation speed is reduced and the torque is increased. The increased torque is transmitted to a rotor (rotational member) of the electromagnetic clutch. When an electric current is not supplied to an electromagnetic coil of the electromagnetic clutch, only the rotor rotates. Since the electromagnetic clutch is configured such that the torque is transmitted from the rotor (an attraction member) to an armature through friction and then from the armature to a shaft connected with it, when an electric current is supplied to the electromagnetic coil thereof, the armature is attracted to the rotor and the torque is transmitted from the rotor to the shaft via the armature.

In this electromagnetic clutch, in order to appropriately generate force (an attractive force) for attracting the armature, slits (magnetic shield grooves) are formed in the armature and the rotor around the circumferential direction (see Japanese Unexamined Patent Application Laid-open No. H02-304221). In this configuration of the electromagnetic clutch, magnetic flux generated by the electromagnetic coil meanders between the rotor and the armature. As a result, the magnetic attractive force between the rotor and the armature is efficiently generated.

The attraction surfaces of the rotor and the armature are separated by the slits into a plurality of annular attraction surfaces. By adjusting areas of the attraction surfaces, the attractive force between the rotor and the armature can be maximized (see Japanese Unexamined Patent Application Laid-open No. 2002-039220).

In recent years, surrounding parts of an electromagnetic clutch, which are used for driving sliding doors, rear doors or the like of automobiles, require severe reductions in cost. For this reason, many surrounding parts of the electromagnetic clutch, such as gears, are made of cheap materials, such as resins, which are poor in strength. The electromagnetic clutch is required to output a torque neither excessive to damage the surrounding parts nor insufficient to drive the doors, under the working condition that both an environmental temperature and supply voltage change in a wide range.

The attractive force of the electromagnetic clutch depends on a magnitude of an electric current supplied to the electromagnetic coil. Generally, an excitation current of the electromagnetic clutch is supplied from an automobile battery which is not equipped with a voltage regulation circuit or the like, so that the magnitude of the electric current varies with voltage of the battery and the environmental temperature. The magnitude of the attractive force is required to be limited in a range when the electromagnetic clutch works under the condition that the voltage of the battery and the environmental temperature change in a wide range. For example, the voltage of the battery varies from 9 to 16 volts and the environmental temperature varies from −30 to 80 degrees centigrade. In the case that the environmental temperature is constant but the voltage of the battery goes up, the electric current supplied to the electromagnetic coil increases in magnitude. On the other hand, in the case that the voltage of the battery is constant and the environmental temperature goes up, the electric resistance of the coil winding increases, so that the electric current decreases in magnitude.

In particular, when an excitation current flowing in the electromagnetic coil is excessive and the attractive force exceeds a preset value thereof, which may result in output of an excessive torque, breakage of surrounding parts (gears and other parts) may occur in association with the above problems due to cost reduction. In order to solve this problem, a torque limiter is separately provided so as not to transmit torque above a predetermined value. However, these methods incur high cost, so that a technique for solving the above problem at low cost is desired.

Although, in the case of sliding door, a driving torque is restricted to a value to prevent from accident in case fingers or objects are nipped by the door, the attractive force may increase due to the variation of the battery voltage and the environmental temperature, so that the output torque may exceed the value. In order to solve this problem, the above torque limiter and a door-position-control mechanism comprised of a control mechanism of a driving motor and a door position sensor are adopted. However, the additional safety device incurs high cost, so that a technique for solving the above problem at low cost is necessary.

According to Japanese Unexamined Patent Application Laid-open No. 2002-039220, an attractive force between an armature and a rotor can be maximized by properly arranging the projective areas of slits in the armature and the rotor. However, the object of this document is only to maximize the attractive force of the electromagnetic clutch, no prevention technique of transmission of an excessive torque due to increase of an excitation current is considered.

### SUMMARY OF THE INVENTION

The present invention has been made in light of the above problems and it is an object of the invention to provide an electromagnetic clutch which can restrict output torque to a predetermined range by improving efficiency of magnetic flux in a magnetic circuit and uniformly saturating magnetic circuit.

According to a first aspect of the present invention, an electromagnetic clutch includes: an armature; a rotor that attracts the armature; a plurality of slits that are formed in the armature and the rotor around circumferential directions thereof; and a plurality of annular attraction surfaces that are formed at both the armature and the rotor which face each other. In the armature and the rotor, at least one of above annular attraction surfaces, and at least one of the circumferential sections cut in the circumferential direction at a position in the armature or the rotor where faces an inner slit wall of the other party are substantially equal to each other in area.

In the aspect of the present invention, the magnetic flux densities are substantially equal at not less than one of the circumferential sections and not less than one of the annular attraction surfaces of the armature and the rotor, so that magnetic saturation substantially simultaneously occurs at a plurality of places of the magnetic circuit. Thus, the excessive increase of the magnetic attractive force between the armature and the rotor with respect to increase of an excitation current tends remarkably saturate. As a result, torque transmitted from the rotor to the armature exhibits saturation tendency, and the armature and the rotor are in a frictional state with slip. Therefore, however the power supply voltage, the use environmental temperature or other condition vary, the torque outputted to the armature can be restricted to a predetermined range, and breakage of the surrounding parts made of resin or the like can be prevented.

In one example that a finger or an object is nipped in a door, even when the excitation current is increased by the power supply voltage and the environmental temperature, the attractive force between the armature and the rotor will be restricted to a safety value by the magnetic saturation, so that the accident due to excessive torque transmission can be prevented.

The expression “substantially equal” means that values of two comparing areas are within a range of ±25% with respect to the median of the two areas, and area of the attraction surface is desirably within a range of ±25% with respect to area of the circumferential section. The expression “substantially simultaneously” means that time period difference is within a time period required for voltage variation of ±10% of supply voltage value at which the attractive force is excessive. Both the selected circumferential section and the attraction surface respectively have at least one of the above portions, and more of them are desirable.

According to a second aspect of the present invention, the circumferential section may be cut in the circumferential direction of a rotational axis of the armature and the rotor, and the position of the circumferential section in a radial direction may correspond with the inner wall of the facing slit nearest to the rotational axis.

In the aspect of the present invention, when the thicknesses of the armature and the rotor are respectively uniform, the area of the above circumferential section is the minimal among all circumferential sections in the magnetic circuit, which the magnetic flux passes through. The areas of the circumferential section and the attraction surface are made substantially equal, so that the magnetic saturation there may substantially simultaneously occur. Therefore, the attractive force can be early saturated effectively and the output torque can be restricted to a predetermined range effectively.

According to a third aspect of the present invention, the number of the attraction surfaces is at least two.

In the aspect of the present invention, if the number of the attraction surfaces that is limited by the space is increased, the number of meandering of the magnetic flux between the armature and the rotor increases, the attractive force required can be maintained even when the excitation current are decreased by the power supply voltage and the environmental temperature. The areas of a plurality of attraction surfaces may be equal, so that the magnetic saturation uniformly occurs in the magnetic circuit. As a result, excessive torque transmission can be effectively prevented.

According to a fourth aspect of the present invention, the circumferential section and the attraction surface may substantially simultaneously exhibit the magnetic saturation when the excitation current reaches a predetermined value.

In the aspect of the present invention, since the circumferential section and the attraction surface substantially simultaneously exhibit the magnetic saturation, the increase tendency of the attractive force can be saturated, and the output torque can be restricted to a predetermined range.

According to a fifth aspect of the present invention, the electromagnetic clutch may further include: a stator yoke in which an electromagnetic coil is provided; and a rotor having a peripheral wall which covers a periphery of the stator yoke. An area of an annular section in a face perpendicular to the rotational axis cut at the peripheral wall of the rotor may be substantially equal to that of both the circumferential section and the attraction surface.

In the aspect of the present invention, the area of the annular section, which is cut in a face perpendicular to the rotational axis at the peripheral wall of the stator yoke, is equal to that of a plurality of the attraction surfaces and a plurality of the circumferential sections. When the outer diameter of the outermost slit is limited to pressing or forging, and the area of the attraction surface outside the above slit cannot be made equal that of either the attraction surface or the circumferential section, the magnetic saturation can be effectively functioned in the embodiment. Since the number of portions in which the magnetic saturation occurs is increased, the saturation tendency of the output torque can be more effectively obtained with respect to the increase of the excitation current.

According to a sixth aspect of the present invention, the electro-magnetic clutch may further include: a stator yoke in which the electromagnetic coil is provided. An annular section may be cut in a face perpendicular to the rotational axis at a peripheral wall forming at the stator yoke, and an area of the annular section is substantially equal to that of both the circumferential section and the attraction surface.

In the aspect of the present invention, the area of the annular section, which is cut in a face perpendicular to the rotational axis at the peripheral wall of the stator yoke, is substantially equal to that of both the attraction surface and the circumferential section. When the outer diameter of the outermost slit is limited to pressing or forging, and the attraction surface outside the above slit cannot be made small, this aspect may be useful for effectively generating the magnetic saturation. Since the number of the portions in which the magnetic saturation occurs is increased, the saturation tendency of the output torque can be more effectively obtained with respect to the increase of the excitation current.

According to a seventh aspect of the present invention, an electro-magnetic clutch may further include: an armature; a rotor that attracts the armature; a plurality of slits that are formed in the armature and the rotor around circumferential directions thereof; and a plurality of annular attraction surfaces that are formed at portions of the armature and the rotor which face each other. When an excitation current supplied to the electromagnetic coil reaches a predetermined value, at least one of the attraction surfaces, and at least one of the circumferential sections, which are cut in the circumferential direction at the position in the armature and the rotor where respectively face an inner wall of the slits, substantially simultaneously exhibit the magnetic saturation.

In the aspect of the present invention, the circumferential section and the attraction surface substantially simultaneously exhibit the magnetic saturation when the excitation current reaches a predetermined value. As a result, the increase tendency of the attractive force is saturated. Therefore, an excessive torque transmitted from the rotor is not entirely transmitted to the armature, and the output torque can be restricted to a predetermined range.

According to an eighth aspect of the present invention, the electro-magnetic clutch may further include: an electromagnetic coil for generating an attractive force between the armature and the rotor. The rotor may be driven by a motor, and voltage may be directly applied to the motor and the electromagnetic coil from a common battery, to energize the motor and the electromagnetic coil.

In the aspect of the present invention, since voltage is directly supplied from the common battery to the motor and the electromagnetic coil without a voltage regulation circuit, when voltage of a power supply becomes high due to some reasons, the driving torque of the motor may be increased, and the excitation current supplied to the electromagnetic coil of the electromagnetic clutch may be increased. When the excitation current reaches a predetermined level, the attractive force may be saturated, so that excessive part of the torque will not be transmitted from the rotor to the armature. That is, the electromagnetic clutch may function as a torque limiter, and excessive torque transmission due to voltage increase of the power supply can be prevented. As a result, breakage of the surrounding parts made of resin or the like can be prevented.

According to a ninth aspect of the present invention, the electro-magnetic clutch may further include: a stator yoke in which an electromagnetic coil is provided. The armature, the rotor, and the stator yoke may form a major part of a magnetic path, and the circumferential section and the attraction surface may have minimal areas in the magnetic path.

In the aspect of the present invention, the magnetic saturation, which occurs when the magnitude of an electric current supplied to the electromagnetic coil is increased, can first occur at the circumferential section and the attraction surface. That is, when the magnetic force generated by the electromagnetic coil becomes strong, the first magnetic saturation can substantially simultaneously occur at a plurality of portions of the magnetic path. As a result, the saturation tendency of the attractive force can be clearly obtained.

In the electromagnetic clutch of the present invention, the efficiency of the magnetic flux in the magnetic circuit can be improved, the magnetic saturation can be uniform, and the output torque can be restricted to a predetermined range. As a result, breakage of the surrounding parts (made of resin, or the like) having low strength can be prevented, and trouble that a finger or an object is nipped in a sliding door, or the like can be prevented.

### BRIEF DESCRIPTION OF THE DRAWINGS

The above object and other advantages of the present invention will become more apparent by describing in detail the preferred embodiment of the present invention with reference to the attached drawings in which;

FIG. 1 is a sectional view showing one example of an electromagnetic clutch according to a first embodiment of the present invention;

FIG. 2 is an exploded sectional view showing the electromagnetic clutch of the first embodiment;

FIG. 3A is a top view and a sectional view showing an armature, and

FIG. 3B is a top view and a sectional view showing a rotor;

FIG. 4 is an enlarged sectional view showing a connected portion of the armature and the rotor in the first embodiment;

FIG. 5 is a perspective view showing the armature or the rotor for explaining an area of a circumferential section;

FIG. 6 is a top view and a sectional view showing the armature and the rotor for explaining an area of an attraction surface;

FIG. 7 is a graph showing the relationship of an attractive force and an excitation current;

FIG. 8 is a block diagram showing one application example of system using the electromagnetic clutch of the first embodiment;

FIG. 9 is an enlarged sectional view showing one example of an electromagnetic clutch according to a second embodiment of the present invention;

FIG. 10 is an enlarged sectional view showing one example of an electromagnetic clutch according to a third embodiment of the present invention;

FIG. 11 is an enlarged sectional view showing one example of an electromagnetic clutch according to a fourth embodiment of the present invention;

FIG. 12 is an enlarged sectional view showing one example of an electromagnetic clutch according to a fifth embodiment of the present invention.

### DETAILED DESCRIPTION OF THE INVENTION

Preferred embodiments of the present invention will be described hereinafter with reference to the drawings

### 1. First Embodiment

### 1.1 Configuration of First Embodiment

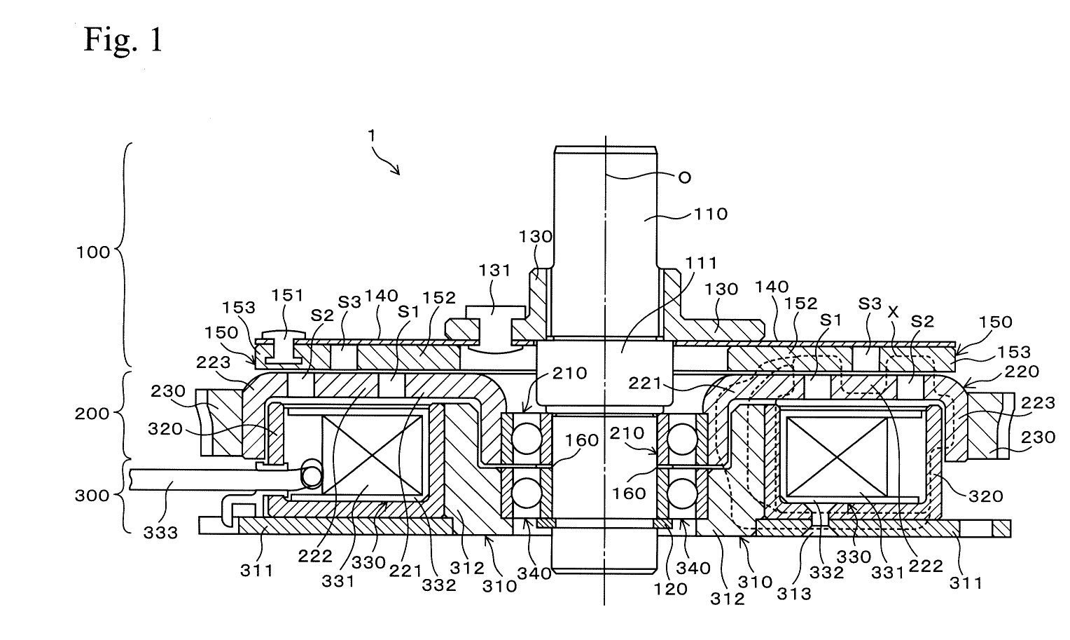

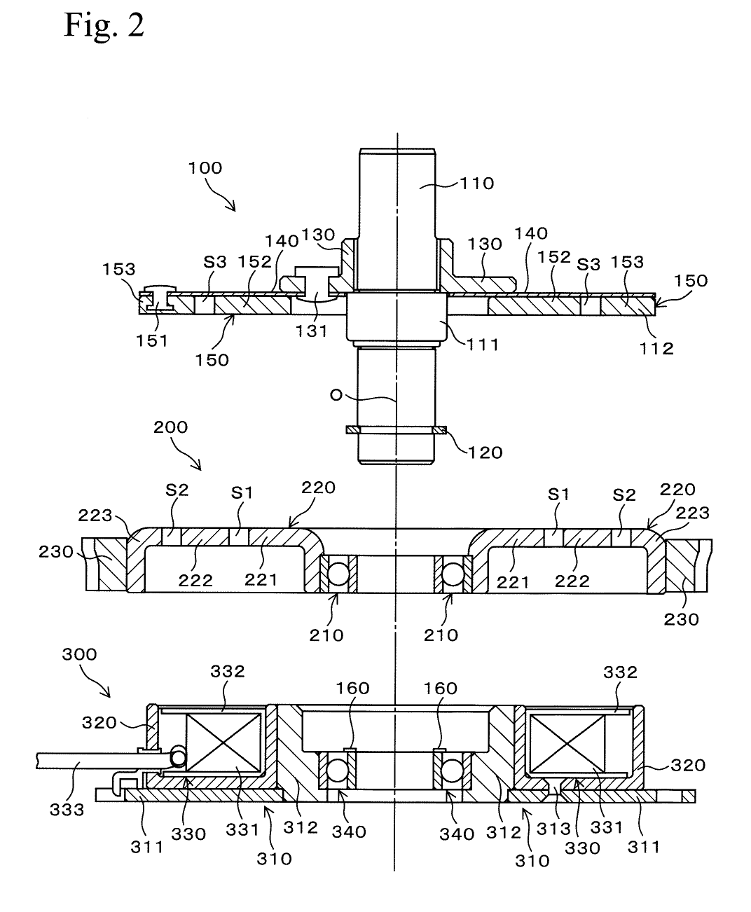

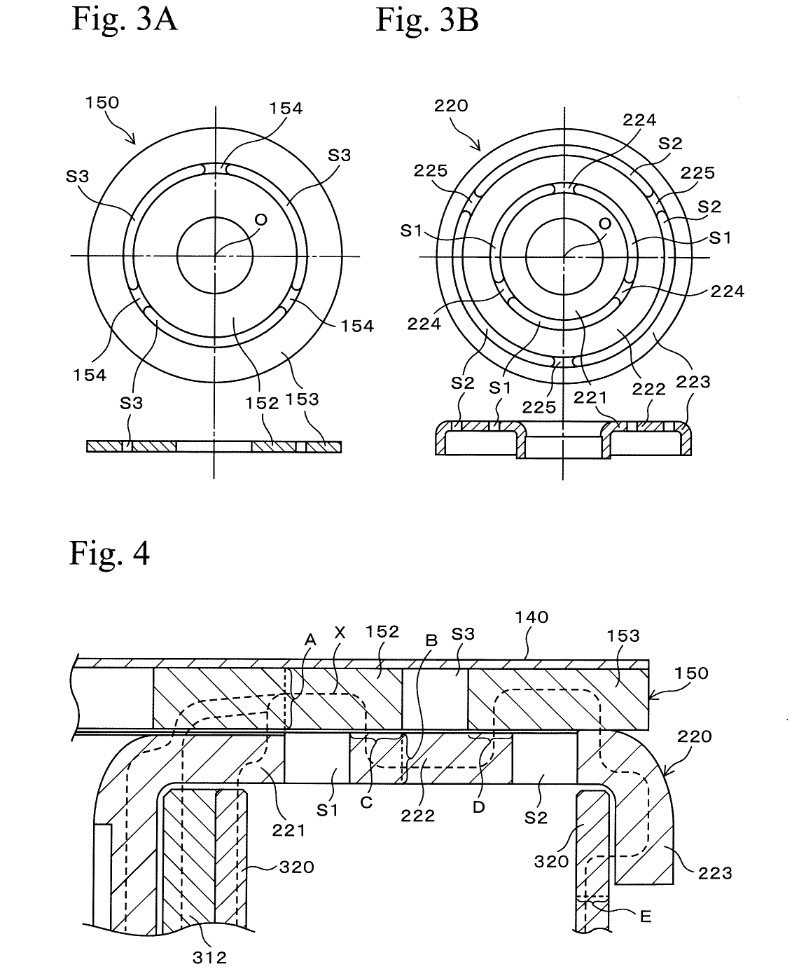

FIG. 1 is a sectional view showing one example of an electromagnetic clutch according to a first embodiment of the present invention. FIG. 2 is an exploded sectional view showing the electromagnetic clutch of the first embodiment. FIG. 3A is a top view and a sectional view showing an armature, and FIG. 3B is a top view and a sectional view showing a rotor.

An electromagnetic clutch 1 is shown in FIGS. 1 and 2. The electromagnetic clutch 1 is equipped with a first power transmission device 100, a second power transmission device 200, and a magnetic flux generation device 300. The first power transmission device 100, the second power transmission device 200, and the magnetic flux generation device 300 are disposed so as to be concentric with each other. The first power transmission device 100 and the second power transmission device 200 are rotatable around an axis O. In the electromagnetic clutch 1, when the first power transmission device 100 is attracted to the second power transmission device 200 by an action of the magnetic flux generation device 300, torque of the second power transmission device 200 is transmitted to the first power transmission device 100.

The first power transmission device 100 is disposed on the upper side of the second power transmission device 200. The first power transmission device 100 has a shaft 110, a C-shaped ring 120, a fixing member 130, several rivets 131, a plate spring 140, an armature 150, and a spacer 160. The first power transmission device 100 transmits the torque from the second power transmission device 200 to an external driving system.

The shaft 110 is a rod and has a locking portion 111 approximately at the center thereof. The locking portion 111 locks the fixing member 130 in a direction of the axis O so as to maintain a distance between the fixing member 130 and the second power transmission device 200. The C-shaped ring 120 is fitted into a groove of lower edge of the shaft 110. The C-shaped ring 120 locks the second power transmission device 200 and the magnetic flux generation device 300 in the direction of the axis O. The shaft 110 functions as a center shaft for rotating the first power transmission device 100 and the second power transmission device 200.

The fixing member 130 is a cylindrical member having an approximately L-shaped section which is cut in a radial direction. The fixing member 130 is fixed on the upper side of the locking portion 111 of the shaft 110. Through the rivets 131, the fixing member 130 fixes the plate spring 140 and the armature 150 to the shaft 110 so as to prevent relative displacement of the plate spring 140 and the armature 150 in a rotational direction.

The plate spring 140 is a disc-shaped elastic member which is thinner than the fixing member 130, has a diameter longer than the fixing member 130, and has an opening at the center thereof. The plate spring 140 is fixed by the rivets 131 at the lower surface of the fixing member 130. The plate spring 140 releases the attracted first power transmission device 100 from the second power transmission device 200 in the direction of the axis O by its elastic force.

The armature 150 is made of a disc-shaped magnetic material which is iron or the like and has an opening at the center thereof. The armature 150 is fixed at the lower surface of the plate spring 140 by rivets 151. When the armature 150 is attracted to the second power transmission device 200, it transmits torque from the second power transmission device 200 to the shaft 110.

The armature 150 has an inner cylindrical body 152 and an outer cylindrical body 153 separated from each other by a slit S3 rounding in a circumferential direction. The inner cylindrical body 152 and the outer cylindrical body 153 are connected by connection portions 154 disposed at several positions. That is, the slit S3 is divided into several portions by the connection portions 154. The lower surfaces of the inner cylindrical body 152 and the outer cylindrical body 153 are attracted to the upper surface of the second power transmission device 200, when the attractive force between them exceeds the releasing force of the plate spring 140.

The second power transmission device 200 is disposed between the first power transmission device 100 and the magnetic flux generation device 300. The second power transmission device 200 has a bearing 210, a rotor 220, and a worm wheel 230. The second power transmission device 200 is rotated around the axis O by a torque generating source (for example, a motor) not shown in the Figures.

The bearing 210 is provided outside the shaft 110. The bearing 210 smoothes rotation of the rotor 220 relative to the shaft 110 so as to reduce energy loss and heat generation caused by friction.

The rotor 220 is a disc-shaped plate that has an opening at the center thereof and has an approximately inverted U-shaped section that is cut in the radial direction. The rotor 220 is made of a magnetic material having the same magnetic permeability as that of the armature 150. The worm wheel 230 is connected to the rotor 220 at the outside thereof. The rotor 220 is rotated by rotation of the worm wheel 230 around the axis O.

The rotor 220 has an inner cylindrical body 221, a middle cylindrical body 222, and an outer cylindrical body 223 separated from each other by inner and outer slits S1 and S2 rounding in the circumferential direction. The inner cylindrical body 221 and the middle cylindrical body 222 are connected by connection portions 224 disposed at several positions. The middle cylindrical body 222 and the outer cylindrical body 223 are connected by connection portions 225 disposed at several positions. That is, the slit S1 is divided into several portions by the connection portions 222, and the slit S2 is divided into several portions by the connection portions 225. The connection portions 224 connect the inner cylindrical body 221 and the middle cylindrical body 222 of the rotor 220. The connection portions 225 connect the middle cylindrical body 222 and the outer cylindrical body 223 of the rotor 220. The upper surfaces of the inner cylindrical body 221, the middle cylindrical body 222 and the outer cylindrical body 223 attract the lower surfaces of the cylindrical bodies 152 and 153 of the armature 150, when the electromagnetic coil is energized.

The slits of the armature 150 and the rotor 220 are different in position from each other in the radial direction. That is, the slit S1 of the rotor 220, the slit S3 of the armature 150, and the slit S2 of the rotor 220 are arranged in turn from the rotational axis O. The slits are spaced a predetermined distance from each other. In this configuration, the cylindrical bodies 152 and 153 of the armature 150 and the inner cylindrical bodies 221, the middle cylindrical body 222 and the outer cylindrical body 223 of the rotor 220 have the attraction surfaces which face each other. These attraction surfaces are four attraction surfaces which are an attraction surface inside the slit S1 and proximate to the rotational axis O, an attraction surface between the slits S1 and S3, an attraction surface between the slits S3 and S2, and an attraction surface outside the slit S2.

Each of the four attraction surfaces has an annular shape having a predetermined inner diameter and a predetermined outer diameter. In the armature 150, two of the four attraction surfaces are formed on the inner cylindrical body 152, and the rest are formed on the outer cylindrical body 153. In the rotor 220, one of the four attraction surfaces is formed on the inner cylindrical body 221, two of the four attraction surfaces are formed on the middle cylindrical body 222, and the rest is formed on the outer cylindrical body 223. The attraction surface of the inner cylindrical body 221 is lower than that of the middle cylindrical body 222, and it is the farthest from the lower surface of the armature 150. The attraction surfaces of the middle cylindrical body 222 are lower than that of the outer cylindrical body 223. That is, the attraction surface of the outer cylindrical body 223 is the most proximate to the lower surface of the armature 150 among the four attraction surfaces of the rotor 220, and only it can contact the armature 150.

The worm wheel 230 is a cylindrical gear provided on the peripheral wall of the rotor 220. Teeth of the worm wheel 230 engage a worm gear, which is not shown in the Figures. A driving shaft of the worm gear is connected to a torque generation source (for example, a motor). The worm wheel 230 transmits torque from the torque generation source to the rotor 220 so as to rotate the rotor 220.

The magnetic flux generation device 300 is disposed at the downward of the second power transmission device 200. The magnetic flux generation device 300 has a housing 310, a stator yoke 320, a magnetic flux generation section 330, and a bearing 340. In the magnetic flux generation device 300, the magnetic flux generation section 330 generates magnetic flux, and the armature 150 of the first power transmission device 100 is thereby attracted to the rotor 220 of the second power transmission device 200, when the induced attractive force exceeds the releasing force of the plate spring 140. The spacer 160 is disposed between inner rings of the two bearings 210 and 340 so as to separate them, and outer rings thereof can thereby relatively rotate.

The housing 310 has a disc-shaped member 311 and a cylindrical member 312, and it is made of a magnetic material having the same magnetic permeability as that of the armature 150 and the rotor 220. The housing 310 has an opening at the center of the disc-shaped member 311, and the cylindrical member 312 tightly contacts the opening of the disc-shaped member 311. That is, the housing 310 has an approximately L-shaped section in the radial direction. The housing 310 supports the electromagnetic clutch 1 as a pedestal, and the stator yoke 320 is provided in the housing 310.

The stator yoke 320 has an approximately cylindrical shape having an opening at the center thereof, and it has an approximately U-shaped section in the radial direction. The stator yoke 320 is provided at the upper side of the disc-shaped member 311 and at the outside of the cylindrical member 312, and it is fixed to the disc-shaped member 311 by fixing member 313. The stator yoke 320 is made of a magnetic material having the same magnetic permeability as that of the armature 150, the rotor 220, and the housing 310. The magnetic flux generation section 330 is provided in the stator yoke 320.

The magnetic flux generation section 330 has an electromagnetic coil 331, a bobbin 332, and a coil lead 333. The bobbin 332 is in an approximately cylindrical shape having an opening at the center thereof, and it has an approximately C-shaped section in the radial direction. The bobbin 332 is disposed in the stator yoke 320. The electromagnetic coil 331 is fixed and is wound around the bobbin 332 in the circumferential direction. An electric current is supplied to the electromagnetic coil 331 via the coil lead 333, so that the electromagnetic coil 331 generates magnetic flux. The rotor 220 attracts the armature 150 by the generation of the magnetic flux. The attractive force depends on the magnitude of the electric current supplied to the electromagnetic coil 331, and the electric current is varied by the voltage of the battery and the environmental temperature.

For example, the higher the voltage of the battery, the more the electric current supplied to the electromagnetic coil 331, so that the attractive force between the rotor 220 and the armature 150 increases. The higher the environmental temperature, the higher the electric resistance of winding of the electromagnetic coil 331, so that the electric current becomes small, and the attractive force between the rotor 220 and the armature 150 becomes small.

The magnetic flux generation section 330 forms a part of magnetic path X which magnetic flux generated by the supplying of the electric current to the electromagnetic coil 331 passes through. As shown in FIG. 1, the magnetic path X is formed by the armature 150, the rotor 220, the stator yoke 320, and the housing 310. In particular, in the armature 150 and the rotor 220, the magnetic path X meanders between the armature 150 and the rotor 220. This is because the magnetic flux is blocked by the slit S3 of the armature 150 and the slits S1 and S2 of the rotor 220.

That is, as shown in FIG. 1, at the slits S1 and S2 in the radial direction of the rotor 220, the magnetic path X passes through the inner cylindrical body 152 and the outer cylindrical body 153 of the armature 150 so as to bypass the slits S1 and S2. As shown in FIG. 1, at the slit S3 in the radial direction of the armature 150, the magnetic path X passes through the middle cylindrical body 222 of the rotor 220 so as to bypass the slit S3.

In this manner, the magnetic flux meanders between the armature 150 and the rotor 220 (from the rotor 220 to the armature 150, and from the armature 150 to the rotor 220), so that the attractive force between the armature 150 and the rotor 220 is strong. Thus, when the electric current is supplied to the electromagnetic coil 331, the armature 150 is attracted to the rotor 220, the plate spring 140 bends toward the rotor 220, the outer portion of the outer cylindrical body 153 of the armature 150, which is outside the slit S2, contacts the rotor 220. As a result, the armature 150 and the rotor 220 are frictionally coupled and rotated together, so that the torque is transmitted from the rotor 220 to the armature 150.

The bearing 340 is provided on the inside of the cylindrical member 312, and it smoothes the rotation of the rotor relative to the shaft 110, thereby reducing energy loss and heat generation due to the friction.

The armature 150, the rotor 220, the stator yoke 320, and the housing 310 which are described above form a magnetic circuit.

### 1.2 Characteristics of Electromagnetic Clutch of First Embodiment

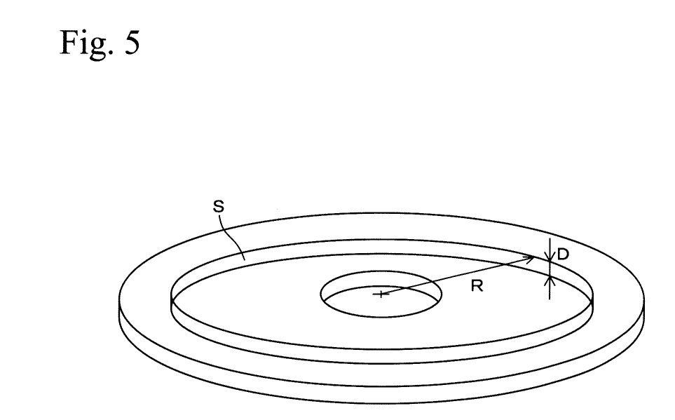

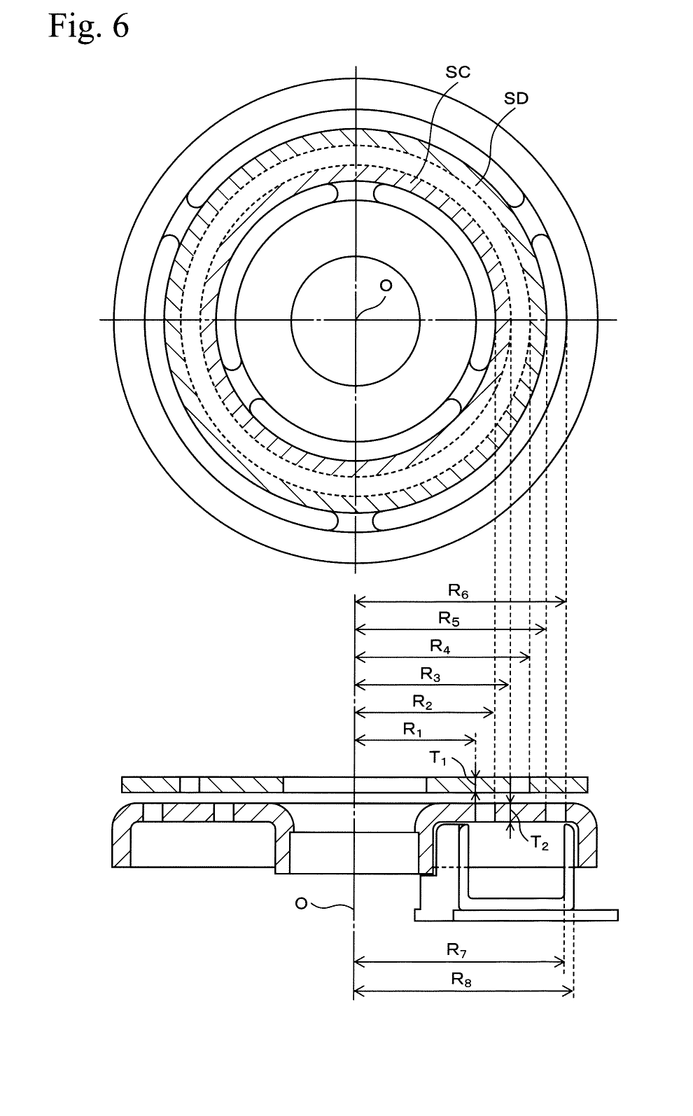

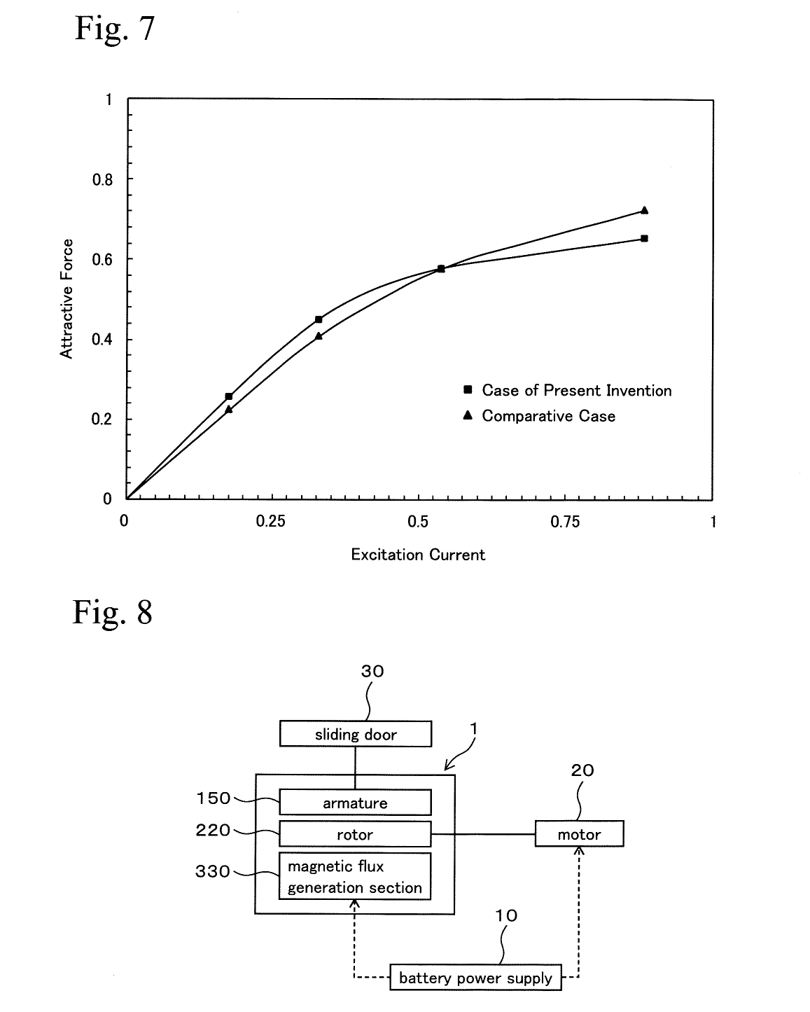

The configuration of the electromagnetic clutch of the first embodiment will be explained hereinafter with reference to FIGS. 4 to 7. FIG. 4 is an enlarged sectional view showing a connected portion of the armature and the rotor in the first embodiment. FIG. 5 is a perspective view showing the armature or the rotor for explaining an area of the circumferential section. FIG. 6 is a perspective view showing the armature and the rotor for explaining an area of an attractive surface. FIG. 7 is a graph showing the relationship of an attractive force and an excitation current.

In the electromagnetic clutch of the first embodiment, areas of circumferential sections, which are cut in the circumferential direction at position in the armature and the rotor where respectively face the inner walls of the slits, are equal to that of annular attraction surfaces of the armature and the rotor, which are separated by the slit in the radial direction.

That is, in both the armature and the rotor, the minimal circumferential section area of the magnetic flux path in the radial direction is equal to the minimal surface area of the magnetic flux path between the armature and the rotor. The areas of the circumferential section and of the attraction surface are equal, so that the magnetic saturation uniformly occurs. One example of the circumferential section is shown in FIG. 4.

Circumferential section A is a side face of a circumference that is cut in the circumferential direction facing an inner wall of the slit S1 proximate to the rotational axis O in the inner cylindrical body 152 of the armature 150. Circumferential section B is a side face of a circumference that is cut in the circumferential direction facing an inner wall of the slit S3 proximate to the rotational axis O in the middle cylindrical body 222 of the rotor 220 that faces the slit S3. Attraction surface C is an attraction surface between the slits S1 and S3. Attraction surface D is an attraction surface between the slits S3 and S2.

In the electromagnetic clutch 1 of the first embodiment, assuming that an area of the circumferential section A is “SA”, an area of the circumferential section B is “SB”, an area of the attraction surface C is “SC”, an area of the attraction surface D is “SD”, the following relationship is obtained as shown in Equation 1,

SA=SB=SC=SD. Equation 1

The areas of the circumferential sections and the attraction surfaces are desirably equal to each other with very high precision. In consideration of material characteristics of the armature and the rotor and production tolerance, the areas may be within a range of ±25% even at maximum with respect to the median, is desirably within a range of ±15% with respect to the median, and is more desirably within a range of ±10% with respect to the median. When a thickness of a steel plate employed is first determined in consideration of the availability problem of the steel plate, the ratio of the area (S1) of the circumferential section and the area (S2) of the attraction surface satisfy the following Equation 2, desirably satisfy the following Equation 3, and more desirably satisfy the following Equation 4,

0.75≦S₂/S₁≦1.25, Equation 2

0.85≦S₂/S₁≦1.15, Equation 3

0.9≦S₂/S₁≦1.1. Equation 4

As shown in FIG. 5, the area S of the circumferential section is expressed by the following Equation 5 using the radius R and the height D,

S=2πRD. Equation 5

Therefore, as shown in FIG. 6, the area SA of the circumferential section A is expressed by the following Equation 6 using radius R₁ and thickness T₁ of the armature 150,

SA=2πR₁T₁. Equation 6

In the same manner, as shown in FIG. 6, the area SB of the circumferential section B is expressed by the following Equation 7 using radius R₃ and thickness T₂ of the rotor 220,

SB=2πR₃T₂. Equation 7

As shown in FIG. 6, the area SC of the attraction surface C is equal to ((an area of the circle having radius R₃)−(an area of the circle having radius R₂)), and it is thereby expressed by the following Equation 8,

SC=π(R²₃−R²₂). Equation 8

In the same manner, as shown in FIG. 6, the area SD of the attraction surface D is equal to ((an area of the circle having radius R₅)−(an area of the circle having radius R₄)), and it is thereby expressed by the following Equation 9,

SD=π(R²₅−R²₄). Equation 9

The area SE of the annular section of the peripheral wall of the stator yoke, which is cut in the radial direction, may be equal to the area of the circumferential section and the area of the attraction surface. That is, the following Equation 10 is obtained,

SA=SB=SC=SD=SE. Equation 10

One example of this annular portion is shown in FIG. 4. The area SE of the annular section E is equal to ((an area of the circle having radius R₈)−(an area of the circle having radius R₇)), and it is thereby expressed by the following Equation 11,

SE=π(R²₈−R²₇). Equation 11

The above circumferential sections A and B are circumferential side faces which are cut in the circumferential direction respectively facing the inner walls of the slits proximate to the rotational axis. When the thicknesses of the attraction portions of the armature and the rotor are respectively uniform in the radial direction, the position of the wall of the slit proximate to the rotational axis corresponds to the minimum section which the magnetic flux passes through. When the area of the circumferential section is equal to that of the attraction surface, the magnetic saturation simultaneously starts up at the circumferential section and the attraction surface.

The annular section E is a portion of the magnetic circuit, and its area is minimum in the magnetic circuit outside the slit S2 which is the farthest from the rotational axis.

That is, the circumferential sections A and B, the attraction surfaces C and D, and the annular section E have minimum areas in respective portions in the magnetic circuit. As shown in FIG. 6, in a magnetic circuit inside radius R₂ the area of the circumferential section A is minimum. In a magnetic circuit ranging between radii R₂ and R₃, the attraction surface C has a minimum area. In a magnetic circuit ranging between radii R₃ and R₄, the area of the circumferential section B is minimum. In a magnetic circuit ranging between radii R₄ and R₅, the attraction surface D has a minimum area. In a magnetic circuit outside radius R₅, the annular section E has a minimum area. That is, in the magnetic path X which the magnetic flux passes through, the circumferential sections A and B, the attraction surfaces C and D, and the annular section E have minimum areas.

According to electromagnetism, an attractive force of an electromagnetic clutch is proportional to the product of the square of the density of the magnetic flux passing through an attraction surface and an area of the attraction surface. The magnetic flux density is mainly determined by the magnitude of an excitation current, the material characteristics of the magnetic circuit, and the minimum area that the magnetic flux passes through. Since the same materials of the magnetic circuit are employed in the above configuration, the areas of the circumferential sections A and B, the attraction surfaces C and D, and the annular section E are equal, and when the excitation current increases, the magnetic saturation simultaneously occurs in these portions. Since portions in which the magnetic saturation occurs are numerous, the saturation tendency of the attractive force is very great, and the attractive force does not simply increase along with the excitation current, but tends to a predetermined value. That is, when the excitation current exceeds a predetermined level, the torque transmitted by the electromagnetic clutch exhibits the saturation tendency.

FIG. 7 is a graph showing an example of the saturation tendency of the attractive force, which are numerical simulation results based on experiment. In FIG. 7, the relationship of the excitation current flowing in the electromagnetic coil 331 and the attractive force acting between the armature 150 and the rotor 220 is shown. In the example, the relationship among the above areas in the magnetic path X of the present invention is shown in Equation 12, and the results are indicated by the mark ▪ in FIG. 7,

SB=(3/2)SA, SC=SA, SD=3SA, SE=2SA. Equation 12

On the other hand, the relationship among the areas in the magnetic path of the comparative case is shown in Equation 13, the results are indicated by the mark ▴ in FIG. 7,

SB=(4/3)SA, SC=(3/2)SA, SD=3SA, SE=2SA. Equation 13

In both the present invention and the comparative cases, each area SA is the minimum of the areas, the ratio of the area SD to the area SA is equal, and the ratio of the area SE to the area SA is equal. In the case of the present invention, the area SC is equal to the area SA, while in the comparative case, the area SC is 1.5 times as large as the area SA. In the case of the present invention, the area SB is 1.5 times as large as the area SA, while in the comparative case, the area SB is about 1.333 times as large as the area SA, and it is smaller than that in the case of the present invention.

As shown in FIG. 7, in the case of the present invention, the magnetic saturation tendency of the attractive force is greatly exhibited. That is, the tendency that the increase of the attractive force by the increase of the excitation current is slowed down is clearly exhibited. The reason is that since the areas of the two portions having minimal cross sections in the magnetic path are equal, the magnetic saturation simultaneously occurs, and the magnetic saturation greatly influences on the saturation tendency of the attractive force. On the other hand, in the comparative case, the saturation tendency of the attractive force is not clear because the magnetic saturation occurs at each portion step-by step in accordance with the increase of the excitation current. In this manner, although the comparative case has a portion having an area smaller than that of the case of the present invention, the saturation tendency of the attractive force in the case of the present invention exhibits more clearly than that in the comparative case. Therefore, the simultaneous occurrence of the magnetic saturation by the increase in the number of the portions having minimal area of the magnetic path X is very effective for the saturation of the attractive force.

In the case of the present invention, only the areas of the two portions are equal. If the number of the portions having the same areas increases, the saturation tendency of the attractive force can be more effective.

For example, in the electromagnetic clutch 1 of the first embodiment, since the magnetic saturation simultaneously occurs at the five portions, the saturation tendency of the output torque with respect to the excitation current can be greater. That is, when the excitation current increases, the effect of restriction of the excessive torque can be sufficiently obtained.

Because the magnetic saturation does not simultaneously occur at a plurality of portions in the comparative case of FIG. 7, the effect of restriction of the excessive torque with respect to the increase of the power supply voltage is unclear. That is, the function as a torque limiter is insufficient.

A concrete setting method of the area shown by the Equation 10 is as follows. First, the value of the excitation current corresponding to the upper limit value of the output torque is set, and the area is set such that the increase tendency of the attractive force is saturated. These values can be analytically obtained, and are desirably obtained by computer simulation and experiment.

In typical designs of electromagnetic clutches, since a steel plate is selected from the view point of required strength, rigidity, and price of both the armature 150 and the rotor 220, first, the thicknesses of the armature 150 and the rotor 220 are determined. In this case, the areas SA and SB are first determined (that is, the thicknesses of the steel plates employed are first determined), and the areas SC and SD are determined in accordance with the determined areas SA and SB. Then, it is confirmed by computer simulation and experiment whether or not the effects of the present invention can be obtained. When the effects are insufficient, the selection of the thicknesses of the steel plates may be reconsidered.

In the magnetic circuit positioned inside radius R₁, the minimal area which the magnetic flux passes through is desirably set to equal to each minimal area of the circumferential section, the attraction surface, and the annular section, respectively. In this case, the saturation tendency of the attractive force can be obtained. The minimal area which the magnetic flux passes through in the magnetic circuit positioned inside radius R₁ may be the area of the attraction surface of the inner cylindrical body 152 of the armature 150 which is proximate to the rotational axis, the area of the attraction surface of the inner cylindrical body 221 of the rotor 220, or an area of annular combination sections that is the sum of the cross-sectional areas of the inner cylindrical body 221 of the rotor 220, the cylindrical member 312 of the housing 310, and the inner peripheral wall of the stator yoke 320.

If there is no enough space to make a plurality of slits, at least one slit is necessary to be made in the rotor. In this case, the area of the circumferential section, which is cut in the circumferential direction at a position in the armature facing the inner wall of the slit, is set to be equal at least one of the attraction surface areas of the rotor 220. The attraction surface of the rotor is separated by the slit into two annular portions in the radial direction. Thus, even when a plurality of slits cannot be formed, the magnetic saturation can be made uniform, and the saturation tendency of the attractive force can be obtained.

### 1.3 Action of First Embodiment

Next, one example of the torque transmission action of the electromagnetic clutch 1 will be explained hereinafter. FIG. 8 is a block diagram showing one example of a slide door driven system using the electromagnetic clutch 1 of the first embodiment. The following explanation will be described with reference to FIGS. 1 and 8.

In the system shown in FIG. 8, a motor 20 and the electromagnetic clutch 1 are energized by a battery power supply 10. The torque for opening and closing of a sliding door 30 is generated by the motor 20. The transmission and non-transmission of the driving torque from the motor 20 to the sliding door 30 is controlled by the electromagnetic clutch 1.

The battery power supply 10 is a DC power supply having no voltage regulation circuit, for example, the voltage is varied from 9 to 16 volts during the service period. The battery power supply 10 directly supplies an excitation current to an electromagnetic coil 33 in the magnetic flux generation section 330 via the coil lead 333. Variation of the output voltage of the battery power supply 10 is directly applied to the electromagnetic coil 331. The motor 20 rotates the rotor 220 via the worm gear (not shown in the Figures) and the worm wheel 230. The sliding door 30 is connected to the shaft 110 which rotates together with the armature 150.

In the transmission of the torque from the motor 20 to the rotor 220, the worm gear decreases the rotation speed and increases the magnitude of the torque. It drives the rotor 220 to rotate around the axis O whether or not the excitation current is supplied to the electromagnetic coil 331.

In the case that the excitation current is not supplied to the electromagnetic coil 331, a gap exists between the armature 150 and the rotor 220, and the torque transmitted from the rotor 220 is not transmitted to the armature 150. Therefore, the shaft 110 also does not rotate, and the torque generated by the motor 20 is not transmitted to the sliding door 30.

When the excitation current is supplied to the electromagnetic coil 331, the magnetic path X is formed. Thus, the attractive force is generated between the armature 150 and the rotor 220, and when the attractive force exceeds the releasing force of the plate spring 140, the armature 150 is attracted to contact the rotor 220. Then, while the rotor 220 rotates, the armature 150 and the rotor 220 are frictionally coupled, the torque is transmitted from the rotor 220 to the armature 150, and the armature 150 is rotated. Therefore, the shaft 110 is rotated by the drive of the armature 150, and the torque is transmitted to the sliding door 30 via the shaft 110.

When the supplying of the excitation current to the electromagnetic coil 331 is stopped, the attractive force between the armature 150 and the rotor 220 disappears, and the armature 150 separates from the rotor 220 by an elastic force of the plate spring 140 in the direction of the axis O. When the armature 150 separates, a gap exists between the armature 150 and the rotor 220, so that the torque transmitted from the rotor 220 is not transmitted to the armature 150. In this manner, the electromagnetic clutch 1 performs transmitting or blocking of the torque generated by the motor 20.

In this case, when the voltage of the battery power supply 10 is higher than a predetermined value, the magnitude of the electric current supplied to the motor 20 is increased, and the driving torque generated by the motor 20 is increased proportionally thereto. Since the excitation current flowing in the electromagnetic coil 331 is increased, the magnetic flux passing through the magnetic path X is increased, and the magnetic flux density is increased. Therefore, the attractive force between the armature 150 and the rotor 220 which are frictionally coupled is increased. However, when the excitation current reaches a predetermined value, the magnetic saturation simultaneously starts up in the circumferential sections A and B, the attraction surfaces C and D, and the annular section E which have minimal areas in the magnetic path X. As a result, the increased amount of the attractive force becomes small for the increase of the excitation current and the increase of the torque of the rotor 220. Therefore, the armature 150 and the rotor 220 are in a frictional state with slip, and the torque transmitted from the rotor 220 is not entirely transmitted to the sliding door 30.

Next, one example of the action of the electromagnetic clutch 1 when a finger, an object, or the like is nipped in the sliding door 30 will be explained hereinafter. When a closing button is depressed, an electric current is supplied to the electromagnetic clutch 1 and the motor 20, the sliding door 30 starts closing. When a finger, an object, or the like is nipped in the sliding door 30 during the closing thereof, a resistance against the rotation of the armature 150 is applied to the armature 150. In this case, when the voltage of the battery power supply 10 is low, the excitation current flowing in the electromagnetic coil 331 is not large, and the attractive force between the armature 150 and the rotor 220 is not large either. Thus, the coupling between the armature 150 and the rotor 220 cannot be maintained against the above resistance, and the armature 150 and the rotor 220 are in a frictional state with slip. As a result, the sliding door 30 cannot be moved forward any more and trouble will not happen.

On the other hand, when the voltage of the battery power supply 10 is high, the excitation current flowing in the electromagnetic coil 331 is accordingly increased. If the magnetic saturation does not occur, the attractive force between the armature 150 and the rotor 220 is strong. In this case, since the motor 20 forcibly rotates the armature 150 against the above resistance, if there is no additional safety device or the safety device does not work, trouble may occur. However, in the first embodiment of the present invention, even if the voltage of the battery power supply 10 is high to some degree, the electromagnetic clutch 1 starts up the magnetic saturation. Thus, the attractive force between the armature 150 and the rotor 220 exhibits a saturation tendency, and the armature 150 and the rotor 220 are in a frictional state with slip in the same manner as in the case of low voltage. In this case, since the torque is not entirely transmitted from the rotor 220 to the armature 150, there is no enough power to drive the sliding door to move forward against the resistance, the nipped finger or the object is safe even if there is no additional safety device. In addition to prevention of the nipping of the finger or the object, breakage of gears made of resin, which is used for driving the sliding door 30, can be prevented. As a result, cost for parts and additional safety device can be reduced, and trouble and breakage of parts can be prevented.

In the first embodiment, an example of a system which drives the sliding door by using the battery power supply is explained above. This example is one of numerous application examples, and the electromagnetic clutch is not limited to the application to this system.

### 2. Second Embodiment

### 2.1 Configuration and Characteristics of Second Embodiment

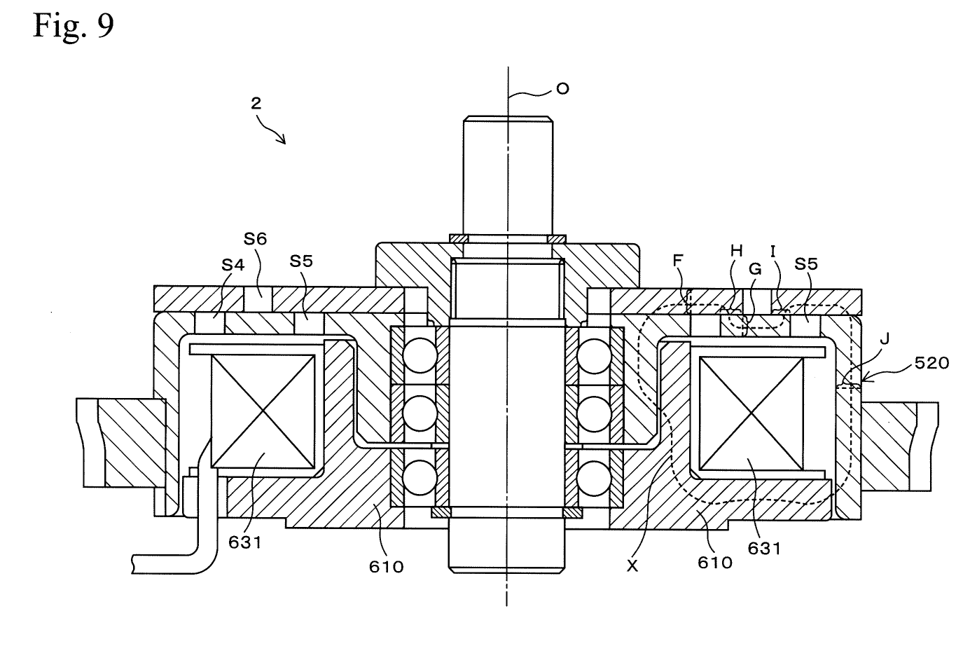

FIG. 9 is an enlarged sectional view showing one example of an electromagnetic clutch of a second embodiment according to the present invention. The configuration and the characteristics of the second embodiment, which are different from that of the first embodiment, will be explained hereinafter.

The electromagnetic clutch 2 has a rotor 520 with a peripheral wall, and the peripheral wall covers peripheries of an electromagnetic coil 631 and a housing 610. This peripheral wall is positioned outside a slit S5 which is the farthest from the rotational axis O, and its cross section in a face perpendicular to the axis O is an annular section J. An area of the annular section J is equal to each area of a circumferential section F, a circumferential section G, an attraction surface H, and an attraction surface I. Alternatively, the areas of the above faces satisfy the above Equations 2 to 4 so as to be equal within a predetermined range.

That is, in a magnetic circuit outside the slit S5 which is the farthest from the rotational axis, the area of the annular section J is minimal. Thus, the magnetic saturation simultaneously occurs in the circumferential section F, the circumferential section G, the attraction surface H, and the attraction surface I, and the attractive force can be restricted to a predetermined value.

### 3. Third Embodiment

### 3.1 Configuration and Characteristics of Third Embodiment

FIG. 10 is an enlarged sectional view showing one example of an electromagnetic clutch of a third embodiment according to the present invention. The configuration and the characteristics of the third embodiment, which are different from that of the first embodiment, will be explained hereinafter.

The electromagnetic clutch 3 is configured such that the slit number of either an armature 750 or a rotor 820 is one more than that of the first embodiment. Compared to the first embodiment, this configuration can generate higher attractive force at the same electric current, and the saturation tendency with respect to the high electric current can be effectively obtained.

The armature 750 has slits S10 and S11 which round in the circumferential direction. The rotor 820 has slits S7 to S9 which round in the circumferential direction.

The slits of the armature 750 and the rotor 820 are disposed at positions different from each other in the radial direction. That is, the slit S7 of the rotor 820, the slit S10 of the armature 750, the slit S8 of the rotor 820, the slit S11 of the armature 750, and the slit S9 of the rotor 820 are arranged in turn from the rotational axis. The slits proximate to each other in the radial direction are spaced a predetermined distance therefrom. Attraction surfaces M, N, O, P, and Q are formed on the armature 750 and the rotor 820.

A circumferential section K has a minimal area which magnetic flux passes through in the armature 750. A circumferential section L has a minimal area which magnetic flux passes through in the rotor 820. Areas of the circumferential sections K and L, and the attraction surfaces M to Q are equal to each other. Alternatively, the areas of the faces satisfy the above Equations 2 to 4 so as to be equal within a predetermined range.

When the excitation current is excessive, the magnetic saturation simultaneously occur at the circumferential sections K and L and the attraction surfaces M to Q, so that the torque outputted to the armature 750 is restricted to a predetermined range. When the excitation current is small, there are numerous portions in which the magnetic flux meanders, so that the attractive force required can be maintained. The number of the slits depends on the attractive force required, the radial dimensions, the strength and the stiffness of the armature 750 and the rotor 820.

### 4. Fourth Embodiment

### 4.1 Configuration and Characteristics of Fourth Embodiment

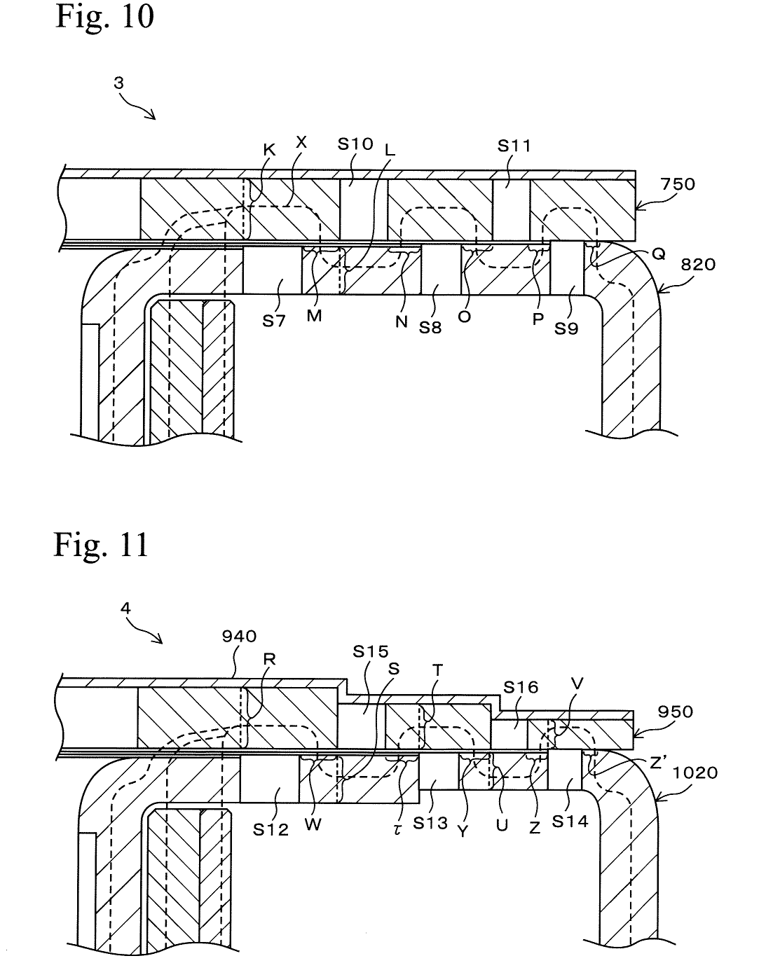

FIG. 11 is an enlarged sectional view showing one example of an electromagnetic clutch of a fourth embodiment according to the present invention. The configuration and the characteristics of the fourth embodiment, which are different from that of the first embodiment, will be explained hereinafter.

In a electromagnetic clutch 4 of the fourth embodiment, the areas of all circumferential sections, which are cut in the circumferential direction at the positions where the armature and the rotor respectively facing the inner wall of a slit of the other party, are the same.

An armature 950 has slits S15 and S16 rounding in the circumferential direction. The armature 950 is thinner step by step in the radial direction from the rotational axis. That is, the armature 950 is thinner at one step at a position of the slit S15 which is proximate to the rotational axis, and it is further thinner at one step at a position of the slit S16 which is the farthest from the rotational axis.

An plate spring 940 is thinner step by step in the same manner as the armature 950. The plate spring 940 separates the armature 950 from a rotor 1020 by an elastic force thereof when supplying an electric current is stopped.

Slits S12 to S14 of the rotor 1020 and the slits of the armature 950 are formed at positions different from each other in the radial direction. The rotor 1020 is thinner step by step from the rotational axis in the radial direction in the same manner as the armature 950.

Circumferential sections R to V are cut in the circumferential direction at the positions where the armature and the rotor respectively facing the inner wall of a slit of the other party, and attraction surfaces W, τ, Y, Z, and Z′ are separated by the slits. Areas of the circumferential sections R to V and the attraction surfaces W, τ, Y, Z, and Z′ are equal. Alternatively, the areas of the faces satisfy the above Equations 2 to 4 so as to be equal within a predetermined range.

That is, in the electromagnetic clutch 4 of the fourth embodiment, the thicknesses of the armature and the rotor are thinner step by step in the radial direction from the rotational axis, so that the number of the circumferential sections and the attraction surfaces where the magnetic saturation simultaneously occurs are increased. The similar effect to that of the fourth embodiment is available in case that the thickness of attraction portions of both the armature and the rotor are made thinner step by step in the radial direction from the rotational axis.

### 5. Fifth Embodiment

### 5.1 Configuration and Characteristics of Fifth Embodiment

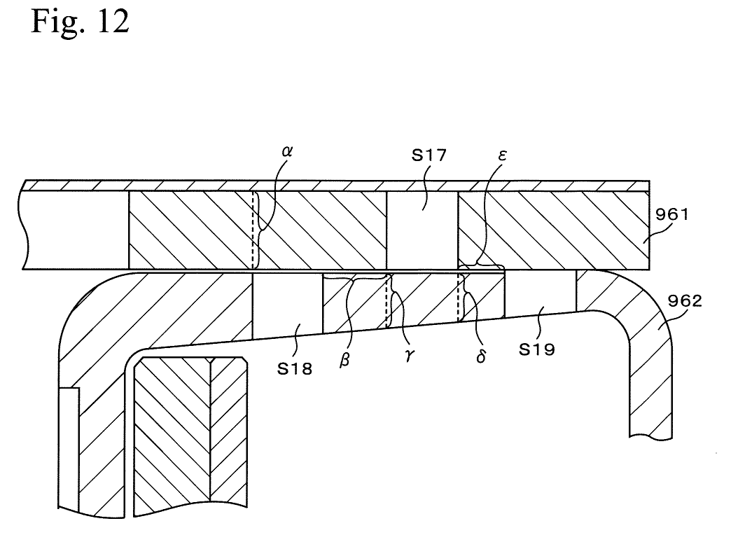

Instead of the step by step thinner thicknesses, the thicknesses of the armature and the rotor may be gradually thinner, that is, may have a tapered section in the radial direction. In this case, either the thickness of the armature or that of the rotor may be made gradually thinner, that is, either of them may have a tapered section in the radial direction. FIG. 12 is an enlarged sectional view showing one example in which a rotor 962 has a tapered section in the radial direction. Slit S17 is formed in a armature 961, and slits S18 and S19 are formed in the rotor 962. The slits have the same shapes as that of other embodiments.

The thickness of the armature 961 is uniform in the radial direction. The rotor 962 has a tapered section such that the thickness of the rotor 962 is thinner toward the outside of the radial direction. In this example, the thickness of the armature 961, the width and the position of the slit S17, the tapered shape condition of the rotor 962, the width and the position of the slits S18 and S19 are adjusted, so that the areas of circumferential section α of the armature 961, attraction surfaces β and ε, circumferential sections γ and δ of the rotor 962, are substantially equal to each other. In particular, the tapered section of the rotor 962 is so made that the areas of the circumferential sections γ and δ are equal to each other. Thus, the number of the places where the magnetic saturation simultaneously occurs is increased, and the effects of the present invention can be effectively achieved.

The thickness variation of the tapered shape of the section of the rotor 962 in the radial direction, that is, the variation of size which is thinner toward the radial direction outside, is adjusted, so that the all circumferential sections between the circumferential sections γ and δ have the same areas. In this case, since the portions in which the magnetic saturation simultaneously occurs are increased, the effects of the present invention can be more effectively obtained. Although in the example shown in FIG. 12, the section of the rotor 962 is made into a tapered shape and that of the armature 961 is uniform in the radial direction, the similar effect is available if the section of the armature 961 is made into the tapered shape and that of the rotor 962 is made into uniform in the radial direction. Alternatively, in the armature 961 and the rotor 962, each thickness thereof may be tapered in section of the radial direction. In the above configuration, each thickness thereof may be partially tapered, and the tapered shape may be changed linearly or in a curved manner toward the radial direction outside.

### 6. Sixth Embodiment

### 6.1 Configuration and Characteristics of Sixth Embodiment

The armature and the rotor can be made of materials different from each other in magnetic permeability. The cylindrical bodies separated by the slits of the armature and the rotor may be different from each other in magnetic permeability. In this case, circumferential sections and attraction surfaces are required to satisfy the following Equation 14,

2πR₁Tμ₁=π(R²_{S1}R²_{S0})μₛ. Equation 14

The left side of Equation 14 is magnetic permeance of the circumferential sections of the rotor or the armature, and the right side of Equation 14 is magnetic permeance of the attraction surfaces of the rotor or the armature. Reference symbol Rₜ denotes a radius from the center axis to the circumferential section, reference symbol Tₜ denotes a thickness of the circumferential section in the axial direction, reference symbol μₜ denotes magnetic permeability of the material of the cylindrical body having the circumferential section, reference symbol Rₛₒ denotes an inner diameter of the attraction surface, reference symbol Rₛ₁ denotes an outer diameter of the attraction surface, reference symbol μₛ denotes the smaller one between magnetic permeability of the armature and that the rotor.

One design example that the magnetic permeability of the armature and the rotor is different from each other will be explained hereinafter. In the configuration shown in FIG. 4, the armature 150 has magnetic permeability μ₁ and the rotor 220 has magnetic permeability μ₂ (μ₁≠μ₂). In this case, when the reference symbols A to D are applied to Equation 14, the following Equation 15 is obtained with reference to FIG. 6.

Reference symbols R₁ to R₆ respectively denote one of inner radii and outer radii of the slits shown in FIG. 6. Reference symbols T₁ and T₂ denote thicknesses of the armature and the attraction surface portion of the rotor, respectively. Reference symbols μₓ denotes a smaller value between the reference symbols μ₁ and μ₂. In this case, the above parameters are set to satisfy Equation 15, and the effects of the embodiment according to the present invention can be obtained,

2πR₁Tμ₁=π(R²₃−R²₂)μₓ=2πR₃T₂μ₂=π(R²₅−R²₄)μₓ. Equation 15

This design is performed in order that permeance of every minimal section and every minimal attraction surface in the magnetic circuit be equal to each other. The permeance expresses the passibility of the magnetic flux in the magnetic circuit, and it corresponds to reciprocal of the magnetic resistance. Permeance P is proportional to the product of the sectional area S of the magnetic circuit and permeability μ of the material, and it is proportional to reciprocal of length L of the magnetic circuit. The equation of the permeance is expressed by the following Equation 16 (see “design and application of AC/DC magnet”, Ohmsha Ltd, Toshiro Isiguro et al., pages 12 to 13),

P=μS/L. Equation 16

According to Equation 16, in a certain length L, to make permeance P of the circumferential section, the attraction surface, and the annular portion of the armature and the rotor made from the materials with different magnetic permeability be equal to each other is to make the product of the areas and magnetic permeability be equal. In the case that the areas are different, by selecting the magnetic permeability of the materials employed for the circumferential section, the attraction surface, and the annular portion, the magnetic saturation can be simultaneously generated at a plurality of portions. That is, the increase tendency of the attractive force is saturated, and the output torque can be restricted to a predetermined range.

### INDUSTRIAL APPLICABILITY

The present invention can be applied to an electromagnetic clutch for restricting output torque to a predetermined range.

What is claimed is:

1. An electromagnetic clutch comprising:
an armature;
a rotor that attracts the armature;
a plurality of slits that are formed in the armature and the rotor around circumferential directions thereof; and
a plurality of annular attraction surfaces that are formed at both the armature and the rotor which face each other,
wherein at least one of the annular attraction surfaces, and at least one of the circumferential sections cut in the circumferential direction at a position in the armature or the rotor where faces an inner slit wall of the other party are substantially equal to each other in area.

2. An electromagnetic clutch according to claim 1,
wherein the circumferential section is cut in the circumferential direction of a rotational axis of the armature and the rotor, and the position of the circumferential section in a radial direction corresponds with the inner wall of the facing slit of the other party nearest the rotational axis.

3. An electromagnetic clutch according to claim 1,
wherein the number of the attraction surfaces is at least two.

4. An electromagnetic clutch according to claim 1,
wherein the circumferential section and the attraction surface substantially simultaneously exhibit magnetic saturation when an excitation current supplied to the electromagnetic clutch reaches a predetermined value.

5. An electromagnetic clutch according to claim 1, wherein
the electromagnetic clutch further comprising:
a stator yoke in which an electromagnetic coil is provided; and
a rotor having a peripheral wall which covers a periphery of the stator yoke,
wherein an area of an annular section in a face perpendicular to the rotational axis cut at the peripheral wall of the rotor is substantially equal to that of both the circumferential section and the attraction surface.

6. An electromagnetic clutch according to claim 1, wherein
the electromagnetic clutch further comprising:
a stator yoke having a peripheral wall in which the electromagnetic coil is provided,
wherein an area of an annular section in a face perpendicular to the rotational axis cut at the peripheral wall of the stator yoke is substantially equal to that of both the circumferential section and the attraction surface.

7. An electromagnetic clutch comprising:
an armature;
a rotor that attracts the armature;
a plurality of slits that are formed in the armature and the rotor around circumferential directions thereof; and
a plurality of annular attraction surfaces that are formed on the armature and the rotor which face each other,
wherein a circumferential section is cut in the circumferential direction at a position in the armature or the rotor where faces one of inner walls of the slits of the other party, and
at least one of the attraction surfaces, and at least one of the circumferential sections substantially simultaneously exhibit the magnetic saturation when an excitation current supplied to the electromagnetic coil reaches a predetermined value.

8. An electromagnetic clutch according to claim 1, wherein the electromagnetic clutch further comprising:
an electromagnetic coil for generating an attractive force between the armature and the rotor,
wherein the rotor is driven by a motor, and
electric power is directly applied to the motor and the electromagnetic coil from a common battery, to energize the motor and the electromagnetic coil.

9. An electromagnetic clutch according to claim 1, wherein
the electromagnetic clutch further comprising:
a stator yoke in which an electromagnetic coil is provided,
wherein the armature, the rotor, and the stator yoke form a major part of a magnetic path, and
the circumferential section and the attraction surface have minimal areas in the magnetic path.

10. An electromagnetic clutch according to claim 7, wherein the electromagnetic clutch further comprising:
an electromagnetic coil for generating an attractive force between the armature and the rotor,
wherein the rotor is driven by a motor, and
electric power is directly applied to the motor and the electromagnetic coil from a common battery, to energize the motor and the electromagnetic coil.

11. An electromagnetic clutch according to claim 7, wherein the electromagnetic clutch further comprising:
a stator yoke in which an electromagnetic coil is provided,
wherein the armature, the rotor, and the stator yoke form a major part of a magnetic path, and
the circumferential section and the attraction surface have minimal areas in the magnetic path.
